(19) United States
(12) Patent Application Publication
(10) Pub. No.: US 2009/0138283 A1
(43) Pub. Date: May 28, 2009

(54) Appointment scheduling system and method

(76) Inventor: Lizbeth Ann Brown, Fremont, NC (US)

Correspondence Address: L. Ann Brown, 963 Woodrow Avenue, Norfolk, VA, 23517, US

(21) Appl. No.: 11/986,817

(22) Filed: Nov. 27, 2007

(51) Int. Cl. G06Q 10/00; G06F 17/30; G06Q 50/00

(52) U.S. Cl. 705/3; 705/8

(57) ABSTRACT

A scheduling program and system includes a database of client information including a field relating to an appointment date. Within a range of the appointment date, preferably one week, the program cues a user to contact a patient to schedule an appointment within the next week. Three attempts are made to schedule the patient before the patient is withheld from the Loop and informed via mail that it is now the patient's responsibility to contact the office to arrange an acceptable appointment. The program further includes a method for tracking “no-show” and non-paying patients.

There are no related patent applications.

This invention did not receive any federal research and development funding.

### FIELD OF THE INVENTION

In general, the instant invention is a scheduling system and method for more efficiently utilizing the office visiting services of a profession. More particularly, the present invention is a loop scheduling program for medical professionals that increase the efficiency of a medical practice. The program includes instructions that review a patient's future appointment date which is stored in a database and cues an operator to contact the patient within one week before the patient's future appointment date. As an added benefit, the scheduling program alerts physicians and office staff of any balance owed by the patient to the physician and considers this balance when scheduling an appointment between the patient and physician. For purposes of this discussion, “an attempt to call” is the effort to contact patients. An “attempt to schedule” is contact made with a patient who refuses to schedule an appointment at the time of the telephone call. Preferably, after three “attempts to schedule” are made and noted in the present system, a card is mailed to the patient informing him that it is his responsibility to contact the caregiver's office to schedule an appointment.

### BACKGROUND OF THE INVENTION

The majority of patient's appointments with physicians are made in one of two ways: 1) the patient telephones the physician's office and requests an appointment, or 2) the patient schedules an appointment for some future date at the conclusion of a doctor visit. Current methods of scheduling allow appointments to be made in advance for up to 18 months. Scheduling an appointment this far in advance creates many problems such as “no-shows” and last minute cancellations which result in an inefficient use of the physician's time and a loss of gross revenue. Moreover, many patients simply do not arrange their schedule more than a week or two in advance.

In most, if not all, medical practices, it is office procedure that as the appointment date draws near, a reminder card is mailed to the patient and/or a reminder telephone call is placed to remind the patient of the upcoming appointment date. The telephone call is placed by either a staff member or an automated call reminder system. Historically, the majority of these reminder calls end up on answering machines or in voice-mail boxes without actual confirmation that the patient intends to keep the appointment. Using this type of office procedure results in large numbers of no-shows and last-minute cancellations and therefore lost revenue to the physicians practice. Thus, the current method of scheduling appointments in a medical practice is very inefficient. The present invention aims to provide a more efficient system and method of scheduling appointments for patients.

### SUMMARY OF THE INVENTION

The instant invention is a database management system that includes a scheduling program and method for more efficiently utilizing the office visiting services of a profession such as a medical professional by generating a list of patients who need to be seen by a physician within the next day or so, not to exceed seven days. In a preferred embodiment, the system is microprocessor-based and includes a loop scheduling program that increases the efficiency of a medical practice. The program includes instructions that review a future appointment date or date when a patient should be seen and cues an appointment specialist (AS) to contact a patient within one week of the future appointment date to schedule an appointment. In this manner, a doctor or other medical provider can more freely allocate their scarce time while maintaining a full schedule of patients who are intending to keep an appointment.

The software process is designed to accommodate a variety of office settings from a single physician's practice to a practice including multiple practices or specialty groups. For purposes of this disclosure, the term database is a collection of related information about a subject organized in a useful manner that provides a base or foundation for procedures or instructions such as information retrieval, drawing conclusions and making decisions. The database is stored in a memory within a microprocessor-based system.

In one embodiment, the program includes a first database that relates to a physician's schedule. This first database includes a plurality of fields that at a minimum, lists the physician's name and information along with a calendar showing the current date and that shows at least the next three days of scheduled patients who the physician will be seeing. Information from this first database is reproduced on a main screen of the program. The patients' names listed in the physician's database are propagated through the use of the software process of the instant invention, as more clearly described hereinafter. The first database may also comprise other physician or provider identification information and necessary scheduling parameters. Other fields may include encounter codes, place of service codes, length of working day, duration of appointments, and referrals to other providers.

A second database lists patients' information or demographics along with a tentative appointment date or range of dates that is periodically searched. Other patient specific data are included in fields of this database. This specific data may include an account number, a date-of-birth, a balance owed by the patient, contact information such as telephone number, and the best time to contact the patient, as well as any other patient specific information necessary to implement the present invention are also provided in this second database. In this second database, a priority code may be assigned to specific patients according to a medical condition or as the future appointment date approaches.

A third database is provided for storing information from the second database that is used to construct the physician's schedule in the first database. The third database is used by the AS to identify patients who should be contacted to schedule an appointment within, but not to exceed, the next seven days. In a second embodiment, all three of these databases may be consolidated into a single database having a physician's schedule and patient data being displayed in the screen shots as discussed hereinafter.

The AS, through the program, periodically searches the tentative appointment date and compares it to the current date or date on which the search is being performed. Preferably, the search is performed at least every business day of operation for a medical practice or other professional practice. On days later in the week, searches may be performed for multiple days and lists built from those whose future appointment date falls on a weekend day. That is, on Friday, the AS may search for those whose future appointment date falls within a range of the next three days, or a three day range. If the medical practice is not open on Saturday or Sunday, the AS may at this time set the comparison day or search date to Saturday or Sunday and continue to look for those whose future appointment days falls within the next three days of Saturday or Sunday. This generates two lists, one having patients' names for those whose future appointment date falls within the next three successive dates of Saturday, and another list of those having a future appointment date falling within the three successive days from Sunday. If the current date matches the tentative appointment date or within a set range of days of the search date, then a patient identifier is copied into the third database. The program then searches either the second or third databases to determine if patient has been given a priority status. From this, a list of patient's needing an appointment within the set range of days from the search is propagated with those having a higher priority being given preference over those who with a lower priority or no priority. These patients' information is copied into the third database to be viewed by the AS. From the third database, the AS contacts the patients and schedules appointments accordingly by copying or pulling a patient's name into a time slot in the physician's schedule displayed on the same screen shot. In this manner, patients with more serious needs or closer to an expected follow-up date are given precedence over those without such needs or who are further from an expected follow-up date.

Various screens are provided to an AS to assist in the scheduling process, including the physicians' schedules. A main screen is provided to the AS and displays data from each of the three databases. In the second embodiment, the information is reproduced and manipulated within the single database. The program holds appointment information until the AS calls the patient to schedule an appointment. Multiple physicians' practices, ordinarily housed within a single office or location, may be managed by the scheduling program such that a single program may service a medical practice having multiple physicians.

### BRIEF DESCRIPTION OF THE DRAWINGS

FIG. 1A is a schematic view of the simplified system for use in a single location embodiment and having multiple databases for practicing the invention. FIG. 1B is a schematic of the simplified system of FIG. 1A and having a single database that simultaneously stores the patients' information, the physicians' information and a loop queue of patient names who need an appointment within the next one to seven days.

FIG. 2 is a schematic view of the system for use in a web-based embodiment that incorporates multiple practices.

FIG. 3 is a first or physician's database for use in the invention. This database includes both static information and dynamic information. The term with respect to “static” indicates that the information provided in the database is fixed. The term “dynamic” indicates that the information periodically changes such as change in the daily schedule of the physician.

FIG. 4 is a second or patient database for use in the invention.

FIG. 5 is a third database that includes representative data of a list in the loop queue database that may be utilized in practicing a first embodiment of the invention and displayed on a portion of the main screen shot.

FIG. 6 is a screen shot of the main screen for managing at least one physician's schedule. This screen shot includes information reproduced from each of the three databases shown in FIGS. 3-5 and 12.

FIG. 7 is a screen shot of the load screen for updating client records in the patient database.

FIG. 8 is a screen shot of the intake form for adding a new patient into the patient database.

FIG. 9 is a system flowchart of a basic process for scheduling an appointment in the present invention.

FIG. 10 is a flowchart of a method for building loop queue data and used in practicing the invention in a first embodiment.

FIG. 11 is a flowchart of a method for building loop queue data and used in practicing the invention in a second embodiment.

FIG. 12 depicts the single database that may be used in implementing the second embodiment of the invention. This database comprises the databases shown in FIGS. 3 and 4 as well as an additional field for tracking patients who should be included in the list.

### DETAILED DESCRIPTION OF THE INVENTION

The present invention is a processor-base system and process that includes software for more efficiently scheduling patients into a physician's schedule. The loop scheduling software is designed to make appointments no further in advance than 7 days from the current date or search date with a patient. A physician's database is compiled as a circuitous loop of patients organized according to the closest upcoming approximate time frame with which the patient should return for a doctor visit. Generally, the physician has made an indication in the patient's record of when this visit should occur. This is referred to as a future appointment date and is copied into a database that includes a plurality of patient's information. For example, the physician may want to see a particular patient in a follow up visit such as a three-month follow-up or a two-week follow-up. This upcoming future appointment date is stored within the patient record within the patient database of the first embodiment, or a patient area of a single database in the second embodiment. In a first embodiment, the program accesses this future appointment date in the patient database and pulls the patient record into the third database which is a list of those needing an appointment within a particular range, such as a three-day range based upon a comparison between the date of the search and the future appointment date. If the future appointment date falls within a defined range of days, then the patient's name is added to the list of those needing appointments. The patient's name advances toward the top of the list of patients who need to schedule an appointment as the future appointment date draws near or according to a priority indicator. That is, the program includes instructions which periodically search all of the patients' records in the physician's database and compares the future appointment date to the date the search is being conducted to determine whether it is within a preset range. The patient information is then transferred into the third database that cues the AS to contact that particular patient to schedule the appointment. On a main screen shot, the AS moves the patient's name from the list of those needing appointments into a scheduling slot on the physician's schedule.

All patients within the physician's database that have been assigned the same time frame are grouped together and advanced to the top of the list to be contacted by the AS. Patients with whom the physician has assigned a “priority” are designated as such and are advanced to the top of the list to be contacted for an appointment before all others having the same future appointment date. These priority codes may include patients' with chronic illness and new medication users, as well as hospital follow-ups.

An AS begins contacting the patients at the top of the list of patients' names in the third database and as displayed in the list in the loop queue database on the main screenshot. Once a patient is contacted, the patient is informed that it is time to schedule the next office visit. They are given the opportunity to schedule their appointment according to availability only one to seven days from the present date or date that the patient database is searched. If a patient is unable to commit to an appointment within this particular time frame, he or she is put back in the list to be contacted again in a predetermined amount of time, preferably within the next 3 days. The patient is contacted a predetermined number of times, preferably 3 times, without a commitment from the patient. If the patient is unable to commit after the AS has contacted the patient three times, he or she is dropped from the list and a note is placed in the patient's file of the patient database to indicate that the patient was contacted three times without an appointment being made. Mail will be generated by the AS at the conclusion of the third unsuccessful attempt at scheduling an appointment informing the patient that it is now their responsibility to contact the practitioner's office to schedule an appointment. The future date field in the patient's record in the patient database is then left blank. The notes field of the patient record indicates when mail was sent to the patient. This new innovative approach to patient scheduling results in only those patients who are able to commit to a specific appointment time being included in the doctor's schedule. This procedure is repeated, one patient at a time, until the physician's schedule is filled with committed patients for a particular day. It is believed that shortening the span of time between appointment setting and the actual appointment time reduces the number of forgotten appointments and eliminates the need for expensive reminder calls and postcards. In instances where a patient cannot be reached, the patient's name may be left in the generated list for future attempts to be made to schedule an appointment.

The main page or screen shot of the loop scheduling program is designed to easily work through the list in the loop queue database of patients to be scheduled. In a preferred embodiment, the main page comprises five vertical columns. The first column on the left of the page displays the current days schedule for a particular physician. This column starts with the first appointment time of the day and continues until the last appointment according to the physician's individual preferences. The first column is generated from the physician's database. The physician has complete flexibility in setting the duration and number of patient visits per day. Patients are preferably scheduled to arrive at the physician's office fifteen minutes prior to the actual time the physician is scheduled to see them. This type of scheduling allows for a front office staff member to pull the patient's records and perform any other administrative needs, if necessary, as well as performing routine patient vital sign collection with the assistant/nurse. The patient appointment time is listed on the left side of the first column. The physician appointment time is listed on the right side of the first column. At the bottom of the column is a separate section for scheduling morning “work-ins” and afternoon “work-ins”. This “work-in” area is reserved for nurse visits, emergencies, and acute last-minute call-in appointments. Again, the number and type of patient visits assigned to the “work-in” area is dictated by the physician's and/or nurse's preferences and can be turned off so that no additional patients can be scheduled.

The second vertical column contains the heart of the program which relates to patient information and comprises the third database. At the top of the column is patient information including a name, date of birth, contact phone numbers, physician name and physician number, type of needed visit (3 month follow-up, office visit, physical, etc.). The fields of the second column are populated by selecting the patient who resides at the top of the list in the loop queue database that is displayed on the main screen. This information is accessed from the patient's record within the physician's database and is specific for that particular physician. In the event the program is used for a multi-physician practice, simply changing the physician name and/or number in the patient block changes the patients to be contacted.

The patient information block also displays other pertinent information such as the number of prior contact attempts. Three attempts are made to schedule an appointment. It should be noted that this number of attempts may be increased or decreased according to a physician's preference. This patient profile block also reflects any unpaid balance and whether there is a hold or wait on scheduling the patient for an appointment due to an unpaid balance per the physician's request as discussed hereinafter. From the patient block, the AS can assign the patient an appointment by simply clicking on an available appointment time or the AS can put the patient back in the loop queue database list to be contacted again in 3 days by selecting the “Back To The Loop” option. When the patient is flagged as having three unsuccessful contact attempts, the AS selects the “Mail” option and the system automatically generates a letter or card as mentioned above.

Once a patient has been assigned an appointment, a visual cue, such as a window, automatically pops up and inquires whether a chart should be pulled for the patient. The AS selects “Yes” or “No”. The visual cue window then disappears and the AS can resume scheduling the next patient. The visual cue window applies to the current or next seven day's appointments according to parameters set by each physician in the program.

In the event the AS has populated the patient block and needs to clear the fields to work with an incoming appointment call, the AS can select a “Back to Loop” option whereby the current patient populating the patient block drops back to the top of the list in the loop queue database and the AS can then proceed to work with the incoming call and populate the patient block with the phone callers demographic information. Some fields within the patient block have “searching” capabilities that will access the physician database to locate the incoming caller's information if the caller is a returning patient. If the caller is a new patient, the AS can select the “New Reg” option whereby a blank “Loop Registration” record pops up to be filled in by the AS during the phone conversation. The program automatically populates the patient profile block and allows for an appointment time to be scheduled once the new patient information is filled in. Once the patient information block has assigned an appointment, the patient information block is clear and the AS can return to the patient at the top of the list in the loop queue database for scheduling.

Searching for a patient in the physician database is easily done by selecting the blank last name field or by inputting the patient account number. The AS begins typing out the letters or numbers in a client identifier. All matches within the database automatically drop below the field being typed in. As additional information is entered, the matches are reduced until an exact match is located. If there is no match, it can be assumed that the patient is not in the database and the AS can select the “New Patient” option that appears at the bottom of the drop-down menu when a search has been activated. If there is a match in the drop-down menu, the AS can select the match and all fields are populated in the patient information block automatically.

Below the patient information block is the list of patients who need to be scheduled for an appointment. The patients' names or identifiers is a list of patients continually changing as patients are selected to populate the patient profile information block. The list in the loop queue database continually updates and organizes patients within the program as new information about patients and their expected return visit is entered into the system. This information is obtained from patient encounter forms. This is a form which is generated at the time a patient is present at the physician's office to be seen. The receptionist clicks on a time slot associated with a patient. A pop-up window appears with options to be selected. These options include, but are not limited to, printing an encounter form, printing a patient statement or calling for a patient's chart. The receptionist can print the encounter form from this window. This form contains information about the patient, the reason the patient is to be seen, patient balance, etc. This form is assigned an appointment number by the program to be reconciled at the end of business when actual charges are entered into the billing system. The assignment of numbers to the form is a control feature that insures that no patient visits are missed and that a patient is charged for each visit The encounter form includes a portion where the physician notes the time frame when a patient should be next seen, the future date, and for what reason. It also allows the doctor to prioritize patients. For example, simple medical problems such as a hangnail will be prioritized below critical health concerns such as heart related issues. At the conclusion of the patient visit, a copy of the encounter form is given back to the AS who uses the form to update the patient record within the database management system.

Updating the patient information within the database can be accomplished by selecting the Patient Load tab at the bottom of the page. Once the Patient Load screen is up, the AS can enter the patient's account number from the encounter form and the load screen populates with current patient information demographics. It is here that the AS can input the next upcoming appointment time frame indicating when the future appointment date, assign a priority to the patient, assign a “wait” or “hold” status, change contact numbers, etc. Once the record is updated, the AS saves the record. The code contained in the “Future Appointment Date” field instructs the program where to store the patient record, either in the list in the loop queue database, the physician's database or elsewhere in the database management system. The list recompiles itself with every new input.

In the event a patient calls and cancels an appointment, the receptionist or AS selects the patient name from the schedule as described before. If the patient is able to reschedule, the patient name can be dragged to an available time slot or, if no slots are available, the patient can be reassigned back to the list in the loop queue database to be contacted in 3 days.

In the event, the physician needs to cancel their appointments, the AS or receptionist selects the patients name from the appointment slot, selects a “Reschedule” option and the patient information block is populated with the patient information. An attempt to contact the patient is made. If the patient is contacted, he/she can be assigned another appointment if one is available, if not they are designated a “Reschedule”, below “Priority” patients, and will be at the top of the Loop for additional contacting until another appointment time is selected. Otherwise, the patient may be assigned to an alternate physician for the visit.

If a patient fails to cancel an appointment in advance, the patient's database or account is annotated as being a “no-show”. The provider determines how many times this will be tolerated before the patient is designated as a “Wait”. Once a patient is designated as “Wait” for being a habitual “no-show”, they are no longer scheduled in advance. They are informed by the AS, or preferably notified by certified mail, that because they have been a “no-show” for a predetermined number of times, they can be scheduled only as a work-in. Until the “wait” status is changed by an administrator, they can be put into the “work-in” only.

Below the program's list in the loop queue database patient queue is a calendar feature. The functions of the calendar feature are described in detail later in this text and allows the schedule of the physician to be modified such that vacation time, holidays, or other times when the physician will not be seeing patients is blocked off or inaccessible to schedule patients.

The next three vertical columns are appointment schedules for the next three working days (weekends are skipped unless otherwise dictated by the physicians practice). These appointment days are organized the same as the first column (current days schedule). These columns can be collapsed by selecting a left arrow below the column or revealed by selecting a right arrow below the column. Collapsing a column allows space on the screen for additional days and dates to be visible on the screen for appointment setting. The number of days out that appointments can be assigned is determined by the physician preferably somewhere between the current day if time is available up to 7 days out. Each column also contains the morning and afternoon work-in feature.

In the event that the AS needs to see the appointment schedule beyond the three days visible on the screen, the AS can collapse the columns and the next three columns will automatically appear on the screen or the AS can use the calendar feature. If the AS selects a particular day on the calendar, that days schedule column will appear on the screen. Physicians decide how many days out they will schedule patients, preferably 1 to 3 but no more than 7 days, the least amount of time between appointment and actual visit decreases the chance of no-shows or cancellations and is more accurate. The Loop is set to not allow scheduling beyond the set point. The set point can be overridden if necessary.

An additional unique feature of the program is the added benefit of being able to easily and immediately assign a patient to another physician who employs the database management and scheduling system. Whenever a physician refers a patient to another physician, instead of taking valuable time on the phone contacting and faxing information between offices, the program allows the patient information to be e-mailed and/or assigned or transferred from one program in a first physician's practice to a second program in the referred physician's practice. The AS populates the load screen with the appropriate patient information. The information contained within the Load Screen is automatically assigned to the partner provider along with the referring physician's comments to the receiving physician. The receiving physician is notified on their system display that there has been an incoming referral which can then be opened and will automatically populate the respective field in the patient profile block in the patient database for scheduling and will be added to the receiving provider's database. Otherwise, if the receiving provider does not have the program, the patient information can be transmitted via e-mail to a non-loop physician with instructions to contact the patient by the receiving physician's AS.

A further aspect of the invention is its ability to track unpaid balances. A vital concern for physicians is the tremendous amount of unpaid balances that they carry for their patients. Millions of dollars go uncollected by physicians every year. The program and system focuses attention on this important area of lost revenue in two important ways. First, it is brought to the patient's attention during the scheduling of an appointment by the AS and secondly, it is brought to the attention of the physician whereby the physician can make a decision regarding the unpaid balance. The program includes an unpaid balance procedure. Contained within the patient profile information block is a field for the patient's unpaid balance to automatically populate. The patient's unpaid balance is shown and according to parameter's set by the physician, a patient is identified as either a “wait” or “hold”. No designation means freely schedule the current patient. “Wait” means the patient has reached the dollar limit with which the physician will carry. In a preferred embodiment, the AS is trained to bring the unpaid balance to the attention of the patient and inform the patient that they cannot be scheduled until the unpaid balance is brought into compliance with the office limits. The AS asks for a payment. If the patient refuses to pay this unpaid balance, the patient is informed that they will be moved to a “wait list” until there balance is brought down to acceptable limits. Payments can be obtained over the phone by using a credit card and therefore they can be scheduled immediately. Otherwise, the patient is withheld from the list on a “wait list” until payment is received. Once payment is obtained, the patient can return to the list for scheduling. “Wait” patients appear in the list only once. After they have been contacted and informed of their status and are assigned to the “wait list”, the patients are flagged and can no longer cycle through the propagated list. Only an authorized person can reassign the patient back to the list for appointments to be scheduled. “Hold” means that the AS should not contact the patient. They are either in collections or are not to be contacted for other reasons. “Hold” patients are flagged and do not appear in the scheduling list, but in the event that they call into the office for an appointment, they can be accessed from the database using the search feature. Once accessed, the AS will see that they are a “Hold” and can refer the call to the office manager. “Waits” and “Holds” cannot be assigned an appointment unless an authorized person overrides the block from scheduling assignment that the patient has been given.

Physicians are kept informed about patient balances by having the patients unpaid balance printed and circled on the patients encounter form. When the physician reviews the encounter form during an office visit with the patient, the physician can note on the encounter form whether to continue to schedule the patient regardless of the balance or to attempt to bring the patient balance down, i.e. wait, before scheduling another appointment, or place the patient on “Hold” until the balance is collected or brought down to predetermined acceptable limits. This notation is what guides the AS who enters the status when updating patient records from their copy of the encounter form.

Additionally, as a matter of procedure, patient balance statements are printed at the same time an encounter form is printed for the days scheduled appointments. It is advised that every patient be presented with a statement of their outstanding balance with every office visit and asked to make a payment at the time of service. If the patient does not have a balance with the physician, a statement is printed anyway with a notation thanking the patient for keeping their account current.

To the right of the calendar feature is a doctor information block. The physician whose schedule is currently being worked with is listed along with the physician's ID number. This block also contains options for freezing the physician's schedule and thus no longer allowing patient appointments to be made. There are also options for blocking off sections of the schedule when the physician will not be available for appointments or entire days.

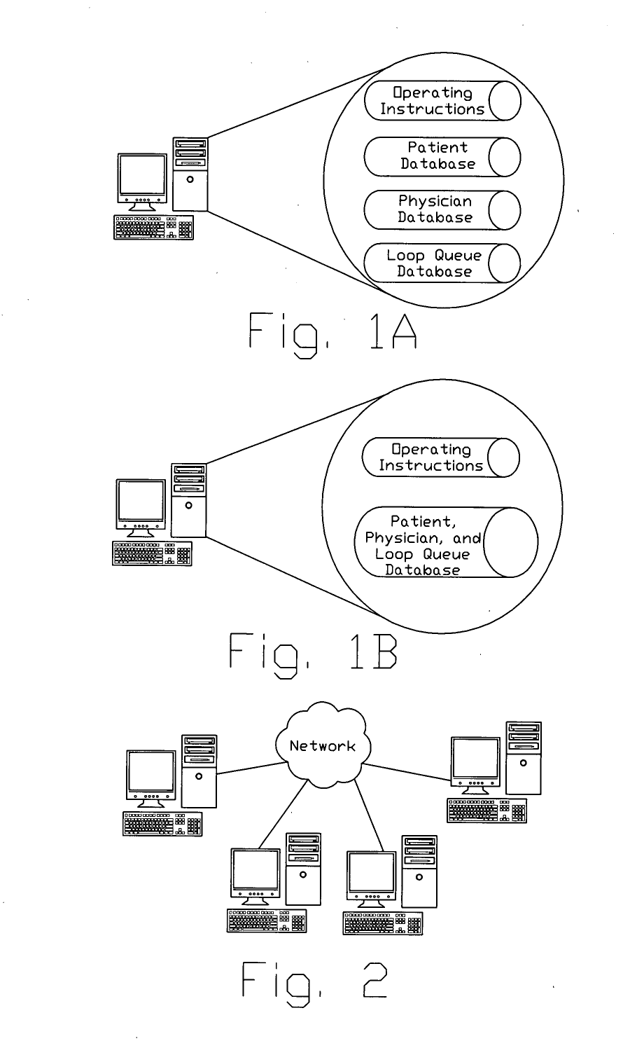

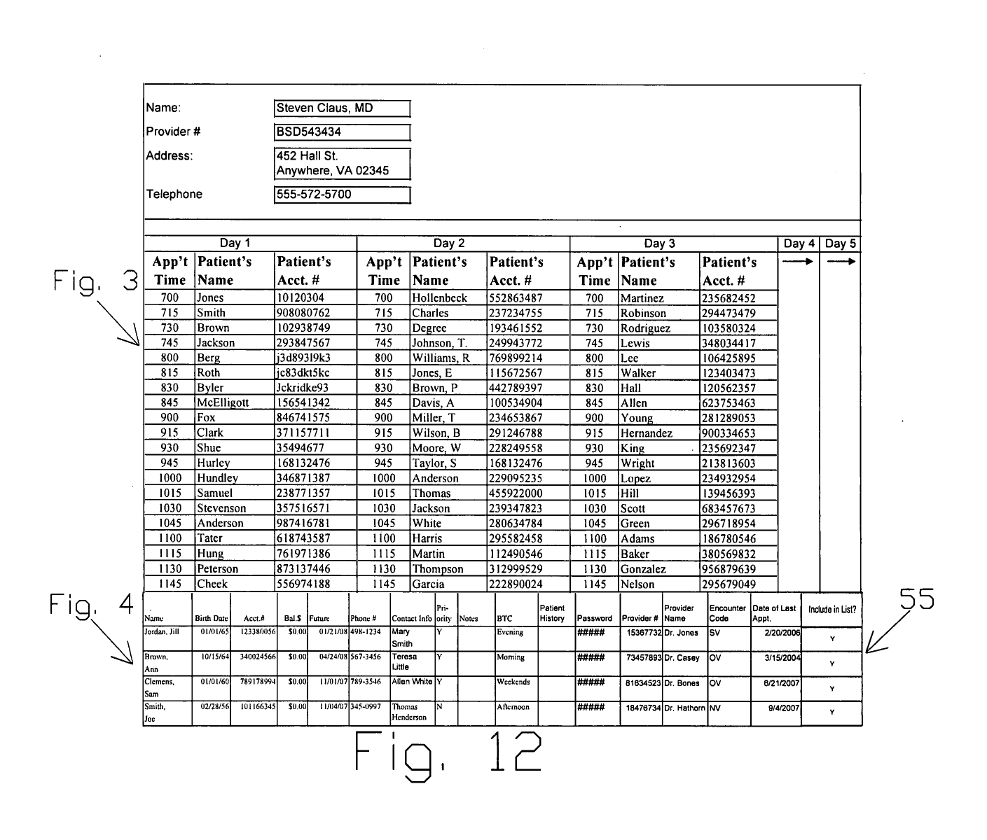

FIG. 1A is a schematic view of the system in a first embodiment. This system includes a microprocessor or computer having a display or output device and including at least one input device such as a keyboard. The microprocessor may further include other data communication devices such as ports for allowing email communications, Internet access or other communications with data storage devices such as floppy disks, flash drives, CD drives or the like. Not shown are backup devices or backup servers for ensuring smooth operation of the program when the primary database or system is corrupted. FIG. 1B is a schematic view of the system in a second embodiment. In the second embodiment, the computer includes operating instructions and a single database that includes physician information, patient information and a loop queue database as discussed hereinafter with respect to FIGS. 11 and 12.

FIG. 2 is a schematic view of a network-based embodiment that incorporates multiple practices. In this embodiment, a plurality of computers or several microprocessor-based systems are coupled together in a network such as the Internet. This embodiment is very useful in coupling multiple practices together. The practices may be housed in one building or may be dispersed over a large geographical area. The network may be any type of network having wired or wireless capabilities, including but not limited to, an Ethernet or Internet based system.

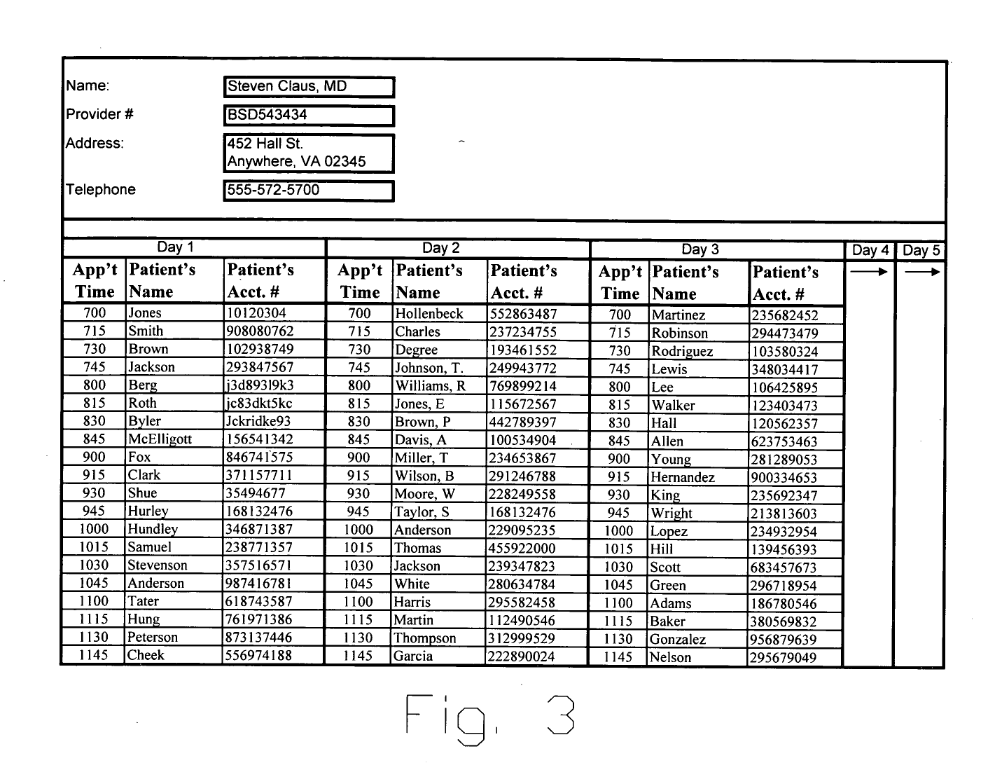

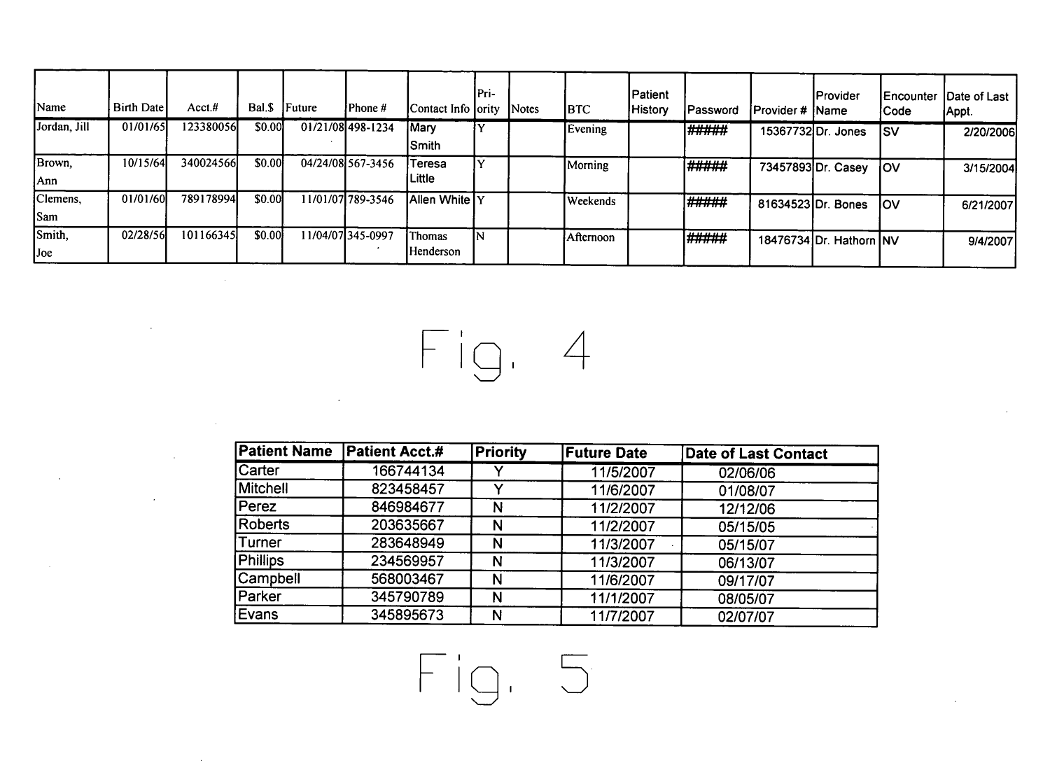

FIG. 3 is a first database for use in the invention. The first database includes one or more physician's schedules. For ease in understanding the invention, only one physician's schedule is shown. Several time slots are provided and may be adjusted to accommodate a particular schedule of a doctor. For example, the instant database depicts the physician as beginning his/her day at seven a.m. and continues until eleven forty-five. The start of the physician's day may begin at eight or nine a.m. or still later. The ending time for the physician may be as late as he/she desires. This first database is shown on the main screen of the program as discussed hereinafter. This database is created by using the loop program to search the second database of patients' information. Several days appointments are stored in this database and are dynamic information. Static information shown includes the physician's name, provider number, address and telephone number. This database is incorporated into the single database shown in FIG. 12.

FIG. 4 is a patient database that includes all the necessary patient information for implementing the scheduling process of the instant invention in the first and second embodiments. The patient database is included in the single database shown in FIG. 12. The patient database includes the names of the patients and birth dates. The birth dates may be utilized to determine when certain medical processes or procedures should be undertaken. For example, a physical and certain blood screening work should be undertaken at various stages in one's life. The program may be modified to include a process whereby the patient database is periodically searched to compare the age of a patient with a target age when these medical processes should be performed. If the patient's age exceeds the target age, then a note is generated to cue the attending physician that such medical processes should be performed during a next visit of the patient.

The patient database further includes a unique account number assigned to each patient. A balance owed by the patient is maintained with the patient identifier and contact information relating to who should be called in the case of an emergency. A telephone number is also included in the patient database, along with a best time to contact “BTC” field indicating when to contact the patient during the week.

Two crucial fields for implementing the invention are provided in the patient database. The fields are the future date and the priority indicators. The future date is utilized by the loop program when creating the physician's scheduling database. The program periodically searches the future date field and compares the data in this field for each patient to the current date or date that the search is being performed. If the future date field is within seven days of the current date, then the patient's information from this database is copied into a third database in the first embodiment. If the future date is outside of the seven day range, then no action is taken by the program. The priority field is used to prioritize the patient's within the third database in the first embodiment. Those with a higher priority are moved to the beginning of the third database to be contacted first. A notes field is provided in the patient database for entering notes. This field may be utilized to store a note relating to when a particular procedure or process should be undertaken by the physician as a result of the patient's age exceeding a certain treatment threshold age. Other fields included in this database are the patient history, a patient password, a provider number, a provider name, an encounter code and a date of last appointment.

FIG. 5 is a third database for temporarily storing patient information to be used by the AS to schedule appointments for the next one to seven days. This third database includes a patient name and account number and a priority indicator. As mentioned above, those patients with a priority are offered an opportunity to schedule an appointment before other patients who do not have a priority assigned to them. The future date is also provided in this database along with the date the patient was last contacted by the AS.

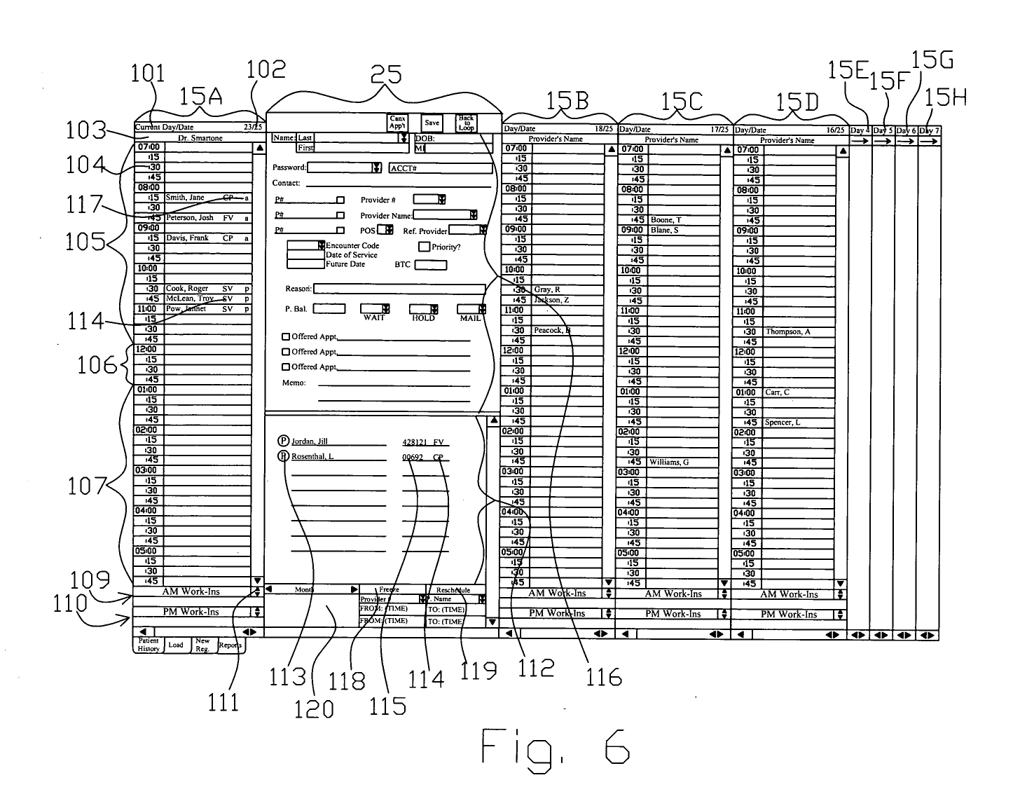

FIG. 6 is a main screenshot or page of the program and includes portions of the three databases, mentioned previously, displayed thereon. This screen shot represents the main screen of the program that includes a physician's daily schedule as periodically reproduced from the first database.

The day of the week and current date 101 automatically appear on the main screen when the microprocessor based system is initiated. The main screen defaults with the current day being shown in one area of the screenshot and having a particular doctor's date schedule below it 15A. Preferably these are arranged on the left side of the screen with the following three working days 15B-15D (as designated by the practitioner or facility) being displayed on the right side of the screen. The day and date can be changed by selecting a different day from the calendar feature 120.

A ratio display 102 shows the number of available appointments to the number of patient commitments that actually arrived for an appointment. A provider's name 103 is arranged atop the screen to indicate whose schedule is being displayed i.e. Dr. Smartone. The number of time slots 104 that appear on the practitioner's daily schedule is determined by the number of patients that the practitioner would like to see. This is established during the staging phase of setting up the software according to the practitioner's desires. The time slots 104 appear next to a patient's name and are displayed for a particular date. Time slot segments or times will appear according to the individual practitioner's requirements. The start time for the day is shown in the A.M. segment 105, break for lunch time 106, and P.M. segment 107 will be set by the practitioner. The number of patients the practitioner would like to see per day is designated by the practitioner. That number determines the number of time slots necessary for scheduling purposes. The number of time slots and the practitioner's start, end and break time requirements determines the length of each office visit (with exceptions and the ability to override the default office visit time assignment). An appointment time told to the patient is set at least 15 minutes in advance of the times displayed on the physician's schedule. This causes the patient to arrive early enough to attend to paperwork. Moreover, it builds in a time buffer should the patient be a few minutes late. For example, if the patient arrives at 9:00 a.m., the practitioner appointment time is 9:15 a.m. The 15 minute differential allows for front-end office administrative work such as paperwork and vital sign collection.

The main page includes an A.M. work-in drop down screen 109 and a P.M. work-in drop down screen 110. These areas are provided for “work-in” patients to be assigned. Work-in patients are patients who walk-in without an appointment, call for an acute, or sick visit, a nurse visit, additional office visits, blood pressure check, or whatever the practitioner would like to be included in this area. Schedule columns 111 can be collapsed or expanded to allow for more visible space on the screen. Collapsing a column reveals the next or following days schedule, etc. Four tab icons are provided below the PM work-ins 110. These icons activate to program causing various screens to be shown and include “Load”, “New Reg.”, “Reports”, and “Patient History”. These tab icons operate similar to the pages of an excel spreadsheet. The AS can flip back and forth between the tabs without an “overlay” on the main screen. “Patient History” is a record of appointments made and kept or “no-showed”.

The third database comprises the patient queue area 112. All patients in the database who are a patient of a specific practitioner and who have been assigned the same future date are fed in a circuitous loop and displayed in this area. The order in which an appointment is scheduled is the oldest date having a priority 113, the oldest date that has been rescheduled, the oldest date with no special designation, the next oldest with priority, the next oldest that has been rescheduled, the next oldest and so on.

A minimum amount of information about the patient appears in the patient queue area 112. This information is at least the last name, first name, patient account number 115, office visit type code or encounter code 114 and provider number and physician's name dropdown screen. A patient arrival status indicator 117 is shown to the right of the encounter code 114 in the appropriate time slot.

Priority codes 113 appear on the main page screen shot and are stored in the second and third databases. These codes appear when the “priority” setting from the patient load screen has been activated. Each code may be indicated in red. The “P” designates that the patient should have priority in appointment setting over all other patients in the queue and should be contacted first. The program automatically sorts these patients and loads these patients at the top of the list in the loop queue database for patients who should be scheduled for an appointment.

Another priority code such as “R” indicates that the appointment has been rescheduled. This code appears when a patient has been bumped from the practitioners schedule such as when the practitioner is unable to meet with the patient due to an emergency or such. The “R” designates that the patient should be scheduled after the “P” patients have been scheduled and before scheduling the remaining patients within the queue. The program automatically sorts these patients and loads them below any “P” patients.

The program includes a calendar feature 120 that displays a month and date. An operator may select whatever month and day to reveal a particular practitioner's schedule plus the following 3 days of schedules. Scrolling back and forth with the appropriate arrows or selecting different days automatically reveals the corresponding schedules. Changing the provider number or the provider name changes the schedule that appears on the screen of the user. In other words, the schedule shown is specific to the provider. Further, the program will not allow scheduling to occur in advance of a set number of days. This feature may be used to block a provider's time for some future date.

Completing the “From time” and “To time” fields and the “From date” and “To date” fields followed by selecting either the “Freeze” box 118 or “Reschedule” box 119 results in the following. “Freezing” means that no appointments can be added to the practitioner's schedule, but appointments can be moved to an “open” date/time or cancelled. “Rescheduling” the practitioners schedule removes all committed patient appointments on the schedule for that particular date or dates and reloads them into the list in the loop queue database after the “priority” patients to be scheduled for the current day. In this instance, all of the patients whose appointments have been cancelled are automatically designated with a priority of “R”.

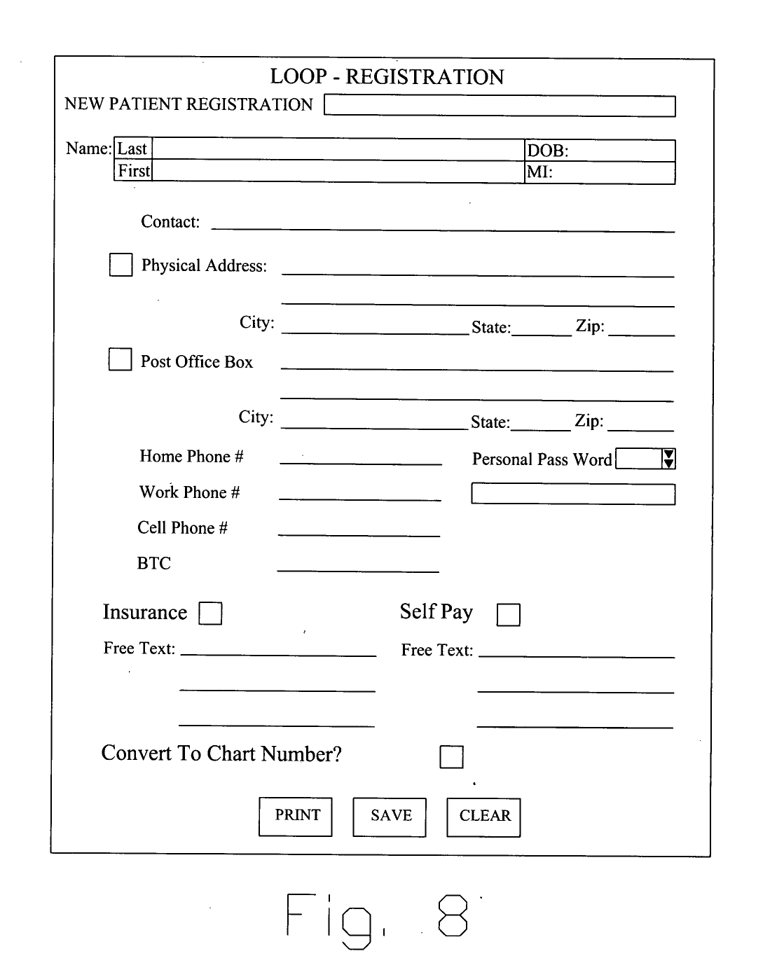

The main screen further includes a patient demographics area 116. This area can be populated in one of five ways. First, a patient's name within the second or third database may be selected by double-clicking a mouse button to automatically populate the demographic area. Alternatively, a search feature within the demographic field may be utilized to find a particular patient and associated data. From a clear, unpopulated demographic area, the operator can input the patient account number and the demographic fields will be populated through accessing the patient information from the patient record within the patient database. Otherwise, an operator may begin typing the patient's last name in the name field of the main screen. In this instance, a drop-down list appears and all patients with the same last name are shown. As additional letters are entered, the displayed list gradually narrows until the desired patient name is revealed. Once the patient is located on the drop-down list, he/she is selected and the patient information automatically populates the demographic fields. If no match appears in the drop-down list, the only selection remaining in the drop-down list will be “Register New Patient” which will be done through the screen shot shown in FIG. 8. From that selection, the AS can manually input demographic information into the appropriate fields. A tool bar 25 includes a, cancel appointment, a save button and a back to loop button. (Note, from here the AS would select “Save” (the information is added to the database with no future date assignment) or the information will automatically be saved if “Back To Loop” option is selected (the record has a future date assignment) or the patient can be immediately scheduled for an available appointment and the information is automatically saved), or Demographic fields are empty. Double-clicking a patient name that is on the practitioner's schedule is another way for populating the patient demographics area.

The appointment that the patient was moved from continues to flash until the patient in the demographics area is reassigned in one of the following ways. Selecting the “CANX APPT” from the demographics area returns the patient to the patient database without a future appointment date assigned. Alternatively the patient can be assigned another available appointment following the same procedure as one would if this were the original appointment assignment (simply click on an available time slot). Otherwise, the future appointment date field can be updated and then assigned “Back To Loop” where the record re-assimilates into the list in the loop queue database.

The “CANX APPT” icon cancels the appointment of the patient in the demographics area. The “Back To Loop” icon sends the patient in the patient demo area back into the list if there is a future appointment date assigned.

The DOB indicates the date-of-birth of the patient and may be used to verify the patient's identity when speaking with the patient on the telephone or to inform the physician when certain medical procedures should be performed. The password is a security question specific to the patient as an alternative for a social security number for verification purposes.

A drop-down arrow reveals the security question such as the patient's mother's maiden name. Every patient has a specific account number assignment. A telephone number is provided with a selection box. The selection box is for speed-dialing. Each practitioner has their own specific provider number. The drop-down reveals all available provider numbers. Selection in the provider number field automatically populates the corresponding provider name and vise-a-versa. The provider name is the practitioner's name. POS is the Point of Service or the location of the provider such as Little Creek Office, Chesapeake Rehab, Jones Blvd. Office, etc. The drop-down menu reveals the possible selections. Referring provider is the name of the referring practitioner. The drop-down list reveals the possible selections. Encounter codes 114 include generally accepted abbreviations for certain types of office visits or can be specific to the practitioner, such as: OV=office visit, NV=nurse visit, CP=complete physical, etc.

The future appointment date is the date of the patient's last office visit plus a specified period of time or an approximate time frame. For example, an indication of 3M means a 3-month follow-up, 1W=1-week follow-up, 365+=annual+one day, etc. The future appointment date is the organizing field upon which the program uses to determine when the patient's name will be moved from the second database into the third database. All patients assigned the same approximate future appointment date are grouped together by the program according to their last office visit date and priority code with the oldest office visit with priority at the top of the list and so on. The BTC field indicates the best time to contact the patient, for example >6 p.m. means after 6 p.m., <9 a.m. means before 9 a.m. The reason field is a free text area for briefly describing the reason for the appointment, i.e. blood pressure check, complete physical, etc.

A “P. Bal.” field indicates the patient unpaid balance owed to the provider. This could be the actual dollar amount or a code could be used as defined by the practitioner. For example, a 1 in the field might indicate that the patient balance is within the $100-$500 range, a 2 might indicate that the patient balance is within the $501-$1000 range. A drop-down menu would reveal the definition of the number indicated.

Patients with a “W” indicator are in the list and will be contacted by the AS. “W” indicates that the patient has been denoted as “wait” which means the AS must wait on scheduling the patient. The assignment of a number in the “W” field is made by the practitioner or other administrative personnel and cannot be changed in the system without the appropriate authorization. A drop-down feature would indicate the reason the “W” assignment was indicated i.e. “Patient Balance is too high”, or “Patient is a Habitual No-Show” etc. “Hold” status means that the AS cannot contact or schedule an appointment with these patients. Patients with a “hold” status are not in the list but only reside in the patient database and can be brought up into the demographics field of the main screenshot through a search procedure but will be locked out of being assigned an appointment.

A “mail” field automatically generates the appropriate mail correspondence to the patient when it is filled in. This is a uniform letter or card stating that the physician's office has attempted to contact the patient on several occasions to schedule a follow-up visit with the particular physician. It also informs the patients that they should contact the office.

When an AS offers an appointment to a patient, it is recorded by the program. An “offered appointment” field is provided such that during a phone encounter with a patient, if no appointment commitment can be obtained, a notation is made in the free text area to the right of the “Offered Appt.” field with the date and a brief description of why the appointment commitment could not be obtained. The program allows for 3 attempts at scheduling an appointment to be made and then mail is sent to the patient requesting that they contact the office when they are ready to commit to an appointment time.

A free text area is provided in the patient database that allows for the AS to input notes about the patient. The program will only allow appointment setting within a range of from 1 to 7 days of the current day or search date. Double-clicking on the “Time” field of a scheduled appointment causes a pop-up menu to appear. The pop-up menu includes options such as printing an encounter form, printing a patient statement, or requesting that a chart be pulled. “Arrived” status indicates whether a patient has checked in for an appointment. For example, the status indicator “P” means that the office is pending the arrival of the patient. A status indicator “A” means the patient has arrived and checked-in for the appointment. The date of the patient's last office visit is also tracked. Selection of the office visit “Encounter Code” from an assigned appointment will bring up a variety of templates that can be printed. These templates are age related “wellness” checks. Example: When a patient turns 50, it is recommended that they have a colonoscopy, bone-density exam, etc., etc. The template is useful during the office visit and serves as a reminder for the physician to discuss and annotate such discussions in the patient's chart regarding the importance of preventative maintenance health checks.

The name of the responsible party with whom all contact with the patient should be made in the event the patient is a minor is also tracked by the program. This may be included in the patient database.

FIG. 8 is an intake or new patient registration screen for entering a patient into the patent database. In addition to the information provided in the second database, this screen allows for insurance information to be entered along with self-pay information. Several actions may be taken from this screen. The form may be printed, saved or cleared of all information. Under the “New Patient Registration,” a temporary number is assigned to a new patient until a chart number can be assigned. The patient's last name, first name, and middle initial are entered into the patient database using free text. A ‘DOB’ or date-of-birth is entered by the AS also. Contact information such as the name of a contact person with whom contact with the patient should be made in case the patient is a minor or needs a guardian to handle their affairs is also recorded by the AS. The patient's physical address or residence is entered into the database. This is flagged if this is the address where the patient receives their mail. If an alternative Post Office Box is used as receiving mail, then it is entered into the system as such. Telephone numbers such as home, cell or work numbers are entered. A “BTC or Best Time to Call indicates the best time to reach the patient to schedule an appointment.

A personal password feature is included in the program. This feature includes a drop down menu that provides a variety of questions that the patient can answer to establish their personal password and confirm their identity when contacting the physician's office over the telephone. This is a security feature in lieu of using social security numbers.

In an “Insurance” region of the screen, insurance information is entered. Otherwise, a region for “Self-Pay” is selected to indicate that the new patient will be self-pay. Memo lines can be used to fill in a disclosure regarding the physician's self-pay policy to recite to the patient prior to scheduling an appointment.

Another feature includes the “Convert to Chart Number” with a check box. This feature may be used depending upon whether program is integrated with the physician's practice management system. If the program is integrated, this selection will enable the user to assign a permanent chart number to the patient chart.

A user can print a registration form, after it is completed, and provide the front office staff a copy of the information. This is important if the program is not integrated with the physician's practice management system. The “Clear” feature clears all the information from the registration screen. The “Save” feature saves the information in the patient's database and automatically populates the patient demographic information on the main screen. Once the information has been populated, the patient can be scheduled for an appointment or put in the patient database for future contacting.

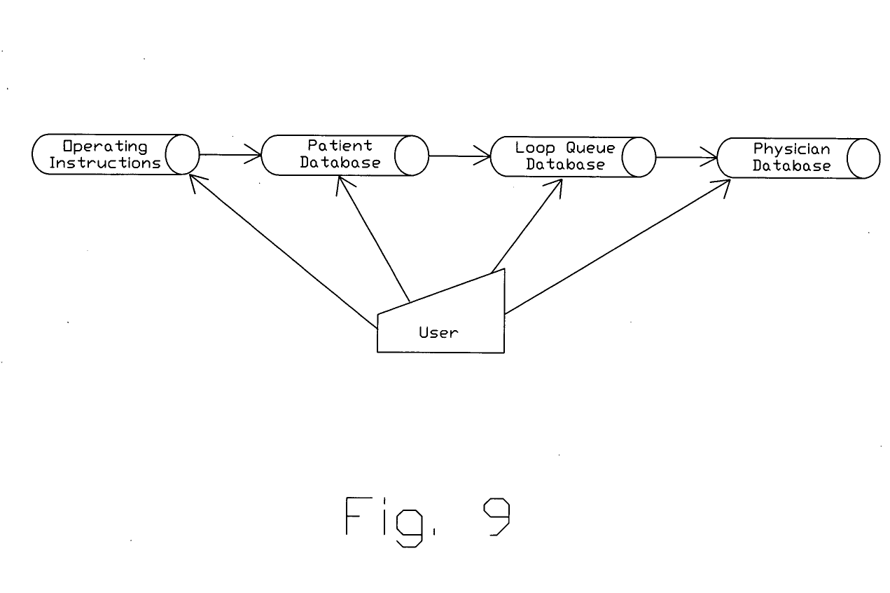

FIG. 9 is a system flowchart showing the basic steps necessary for achieving the invention. These steps include providing operating instructions as set forth herein and building a database management system that includes a patient database as discussed above. The user initiates the operating instructions. From the patient database, the operating instructions cause the program to determine whether a patient should be scheduled to meet a physician within the next seven days. If so, the patient's information is copied into another database (loop queue database) that comprises the list of those needing an appointment with the provider within the present range of days, prioritized according to certain conditions, and the patient is contacted and an appointment is confirmed. The AS clicks and drags the patient's name into an appropriate timeslot of a physician's schedule which is managed in the physician's database. When the patient arrives at the physician's office, office personnel generate an “encounter form” that is updated during the office visit and returned to the AS at the end of the appointment to update patient records. In general, an encounter form contains patient demographic and account information, preprinted forms of common office procedure specific to the specialty practice. It may also include evaluation and management and procedure codes specific to a physician specialty. Otherwise, it may include a new patient worksheet for physicians to record medical notes on the encounter.

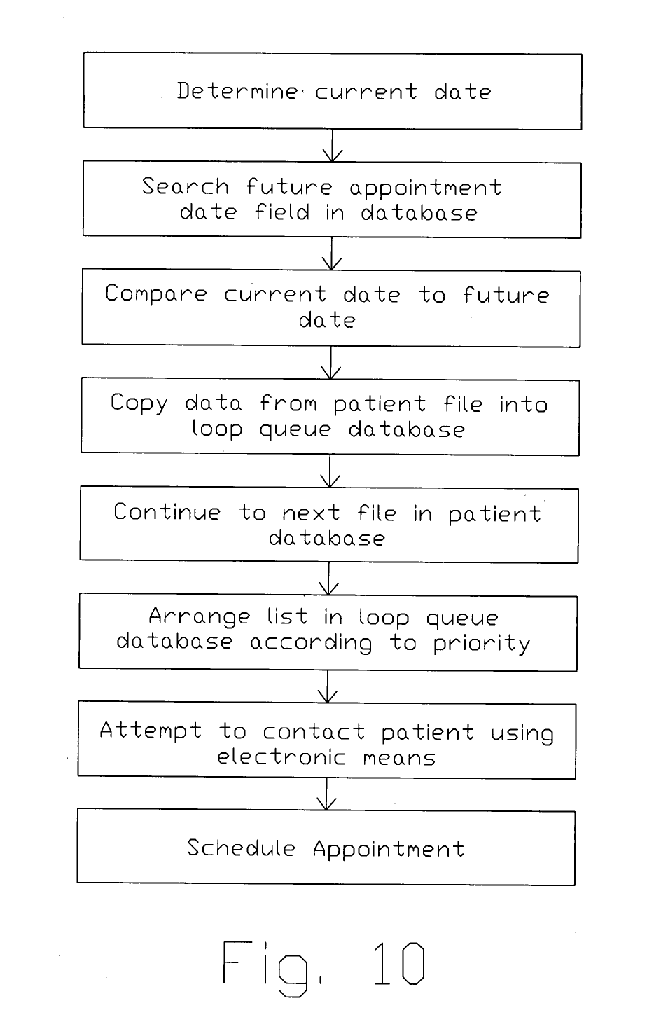

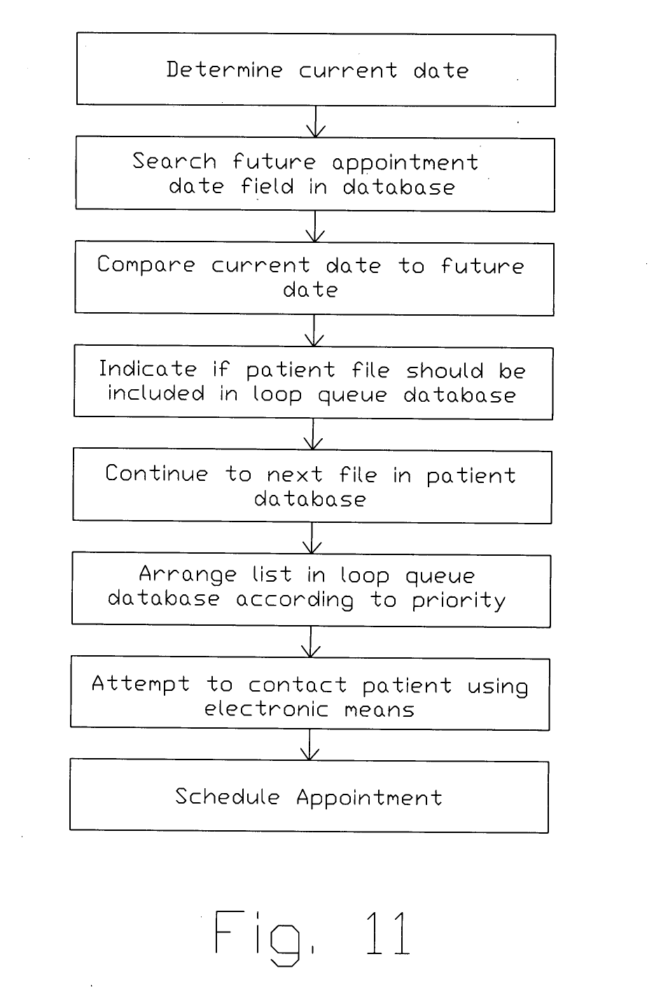

FIG. 10 shows the basic steps for creating a schedule for a physician using the loop program. The current date or date of search is determined by the microprocessor. This is compared to the future appointment date field in the patient database. If the current date is within a range of one to seven days of the future appointment date, then certain data from the patient database, such as an identifier and priority indicator, are copied into the database comprising a list of patients that need to see the physician within a range of days. This process is continued until the entirety of the patient records have been searched for a particular physician. This list that has been created is then arranged according to priorities. The AS then contacts the patients according to their respective position in the list stored in the third database to schedule an appointment. If the patient is not contacted then his/her record is left on the list. Otherwise if they have been contacted a preset amount of times, such as three, and cannot commit to an appointment, mail is generated as mentioned previously.

Various reports may be generated by accessing the “Reports” feature tab and displayed by the program. These reports may include the practitioner's volume or the number of patients seen for a specific time period per practitioner and/or per service location. A ratio report may be generated per practitioner and/or per service location. The ratio report indicates the number of patients seen to the number of available appointments. A telephone log report indicates the number of calls to each patient name, telephone number, date, time, and the name of the AS. An operator log indicates the calls made per appointment specialist for a specific time period. A no show or cancellation log indicates the number of no-shows and cancellations per practitioner and/or per service location for a specific time period. A wait list indicates patient names and reasons for the wait list assignment, as well as the date the assignment was made and by which practitioner. A hold list indicates patient names and reasons for the hold assignment, as well as the date the assignment was made and by which practitioner. A future date list indicates the number of patients in the loop queue for a future appointment date within a specific time period by practitioner and/or by point of service. Additional statistical reports will be custom-built per practitioner requests.

In FIG. 11, the physicians' database, patients' database and loop queue database are consolidated into a single database that includes all of the elements of the doctors' database and the patients' database, along with an indicator field 55 that indicates when a patient's name should be added into the list of patients to be scheduled within the next one to seven days. The operating instructions create the list of patients to be scheduled by placing an identifier in an additional field 55 as shown in FIG. 12. Next, the list of patients are prioritized according to the priority. These are then displayed on the main screen in the loop queue database section in order of their priority. When the AS moves the patient's name from the list into an appropriate scheduling slot of a physician, the name is automatically removed from the list of patients in the loop queue database section and the indicator field is changed to reflect that the scheduled patient should not be included in the list the next time the microprocessor searches the database.

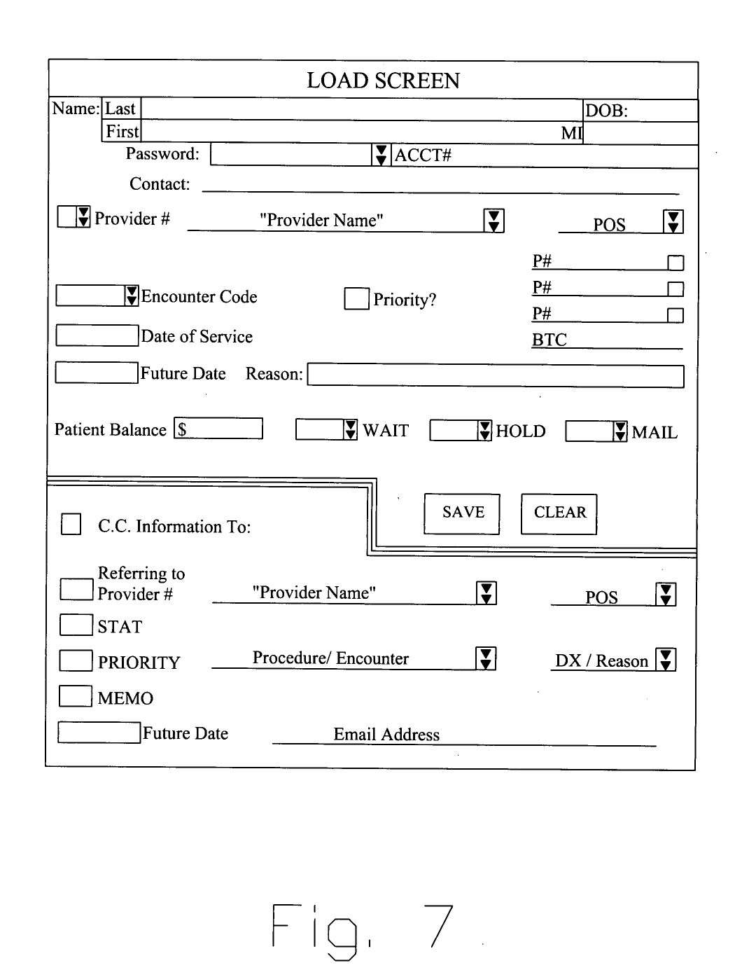

FIG. 7 is a screenshot of a load screen for updating the patient information within the patient database. The Patient Load screen is accessed through the “Load” tab. Once the load screen is up, the AS can enter the patient's account number from the encounter form and the load screen populates with current patient information demographics. It is here that the AS can input the next upcoming appointment time frame indicating when the future appointment date, assign a priority to the patient, assign a “wait” or “hold” status, change contact numbers, etc. Once the record is updated, the AS saves the record. The code contained in the “Future Appointment Date” field instructs the program where to store the patient record, either in the list in the loop queue database, the physician's database or elsewhere in the database management system. The list recompiles itself with every new input. The load screen includes the patient's name including first, last and middle initial. A date-of-birth is included in this screen shot. A physician's name and number or provider's number and name is provided. The point of service along with the encounter and date of service are also provided in this screen shot. A reason field for visiting the office is included. The patient's balance and telephone numbers are provided. The best time to contact and the dropdown mail feature is included. A carbon copy information section includes a referring provider's name and number. Stat, priority, memo and future date are included in the load screenshot.

The aforementioned process may be stored on a medium such as a disk, drive, flash drive, or any other such data storage devices.

It is to be understood that the invention is not limited to the exact construction illustrated and described above. Various changes and modifications may be made without departing from the spirit and the scope of the invention as defined in the following claims. While the invention has been described with respect to preferred embodiments, it is intended that all matter contained in the above description or shown in the accompanying drawings shall be interpreted as illustrative and not in limiting sense. From the above disclosure of the general principles of the present invention and the preceding detailed description, those skilled in the art will readily comprehend the various modifications to which the present invention is susceptible. Therefore, the scope of the invention should be limited only by the following claims and equivalents thereof.

We claim:

1. A system for scheduling appointments comprising:
a microprocessor-based system comprising an output device, an input device, and, a data storage device, said microprocessor-based system including a database having a plurality of patients and patient specific information listed therein, said patient specific information including at least each patient's name, an account number for each patient and a future date when each patient should see a caregiver; and,
a program stored in said data storage device that includes instructions that periodically cause the microprocessor-based system to review the future date for each patient in the database and create a list of patients who need an appointment with the caregiver within a range of one to seven days of a date on which the microprocessor-based system has reviewed the patients' future dates, the list of patients is displayed on the output device such that each patient on the list is called and offered an opportunity to schedule an appointment within the next seven days.

2. The system of claim 1 wherein said program stored in the data storage device includes instructions which compare a current date of when the microprocessor-based system is reviewed to the future date of each patient and if the current date is within a range of one to seven days of the future date then data from that particular patient are copied into the list of patients and the list is arranged according to priorities assigned to each patient such that patients having a priority code are offered an opportunity to schedule an appointment before those patients on the list who do not have a priority code.

3. The system of claim 1 further comprising a “wait” feature that includes operating instructions which allows a caregiver or caregiver's representative to flag a patient for failing to keep past appointments such that a patient whose patient specific information includes a “wait” designation is no longer scheduled to meet the caregiver and is informed that the patient can only be scheduled as a work-in.

4. The system of claim 1 that includes operating instructions that allow the caregiver or caregiver's representative to designate a patient as “hold” because the patient is not to be contacted wherein such patients that are designated “hold” patients do not appear in the list of patients, said “hold” patients being accessed from the database using a search feature.

5. The system of claim 1 further including a main screenshot that displays patient information, caregiver information and the list of patients who need to see a caregiver within the next seven days, said main screenshot including a caregiver's daily schedule for a plurality of days divided into time slots into which a patient is scheduled, said main screen further including a day of the week and current date, an A.M. work-in dropdown screen, a P.M. work-in dropdown screen, a patient queue area that displays the list of patients who need appointments within the next seven days, a patient arrival status indicator, encounter code, priority codes, and a calendar feature that displays a month and date such that a caregiver or a caregiver's representative may select whatever month and day to reveal the caregiver's schedule, the main screen further includes a patient demographics area, a tool bar that includes a cancel appointment activation icon, a save activation icon and a back to loop activation icon, a patient balance area that indicates any unpaid balance owed to the caregiver by the patient, wait and hold indicators, an offered appointment field, and a notes entry area. The main screen also displays tabs at the bottom of the page for accessing a “Patient History” page, a “Load” screen page, “Reports” page, and “New Reg” page.

6. The system of claim 1 wherein said database includes a daily work schedule for at least one caregiver, said daily work schedule comprising time slots, each time slot associated with a patient's name and having an arrival status and encounter code shown on a main screenshot.

7. The system of claim 1 wherein microprocessor-based system includes operating instructions and at least one database comprising a plurality of patients' patient specific information including a patient's name, a date-of-birth, an account number, a balance owed, a future date, a telephone number, a priority code, a best-time-to-contact, a patient history, a password, a caregiver number, a caregiver name, an encounter code and a date of last appointment, the at least one database further comprising a provider's address and telephone number and a schedule of the provider's next seven working days arranged as time slots.

8. A method of scheduling appointments for a medical practice comprising the steps of:
providing a microprocessor-based system;
providing a program that periodically cause the microprocessor-based system to review a future date for each patient in a database and create a list of patients who need an appointment with a caregiver within a range of one to seven days of a date on which the microprocessor-based system has reviewed the patients' future dates;
entering patient information into the microprocessor-based system;
entering a date on which an appointment is to be made into a database;
periodically searching the database and prioritizing an appointment schedule according to patients that should be seen within the next seven days;
contacting the patients that should be seen within the next seven days and attempting to schedule the patients for an appointment within the next seven days; and,
continuing contacting patients until a physician's schedule is full for a particular day.

9. The method of claim 8 further including prioritizing the list of patients according to medical conditions.

10. The method of claim 8 further comprising allowing a caregiver or a caregiver's representative to flag a patient for failing to keep past appointments such that a patient whose patient specific information includes a “wait” designation is no longer scheduled to meet the caregiver and is informed that the patient can only be scheduled as a work-in.

11. The method of claim 8 further comprising allow the caregiver or caregiver's representative to designate a patient as “hold” because the patient is not to be contacted wherein such patients that are designated “hold” patients do not appear in the list of patients, and said “hold” patients being accessed from the database using a search feature.

12. The method of claim 8 further including providing a main screenshot that displays patient information, caregiver information and the list of patients who need to see a caregiver within the next seven days, said main screenshot including a caregiver's daily schedule for a plurality of days divided into time slots into which a patient is scheduled, said main screen further including a day of the week and current date, an A.M. work-in dropdown screen, a P.M. work-in dropdown screen, a patient queue area that displays the list of patients who need appointments within the next seven days, a patient arrival status indicator, encounter code, priority codes, and a calendar feature that displays a month and date such that a caregiver or a caregiver's representative may select whatever month and day to reveal the caregiver's schedule, the main screen further includes a patient demographics area, a tool bar that includes a cancel appointment activation icon, a save activation icon and a back to loop activation icon, a patient balance area that indicates any unpaid balance owed to the caregiver by the patient, wait and hold indicators, an offered appointment field, and a notes entry area. The main screen also displays tabs at the bottom of the page for accessing a “Patient History” page, a “Load” screen page, “Reports” page, and “New Reg” page.

13. The method of claim 8 wherein the caregiver or caregiver's representative enters information into the database that includes a daily work schedule for at least one caregiver, said daily work schedule comprising time slots, each time slot associated with a patient's name and having an arrival status and encounter code shown on a main screenshot.

14. A medium that stores instructions that operate a system for scheduling appointments comprising a microprocessor-based system comprising an output device, an input device, and, a data storage device, said microprocessor-based system including a database having a plurality of patients and patient specific information listed therein, said patient specific information including at least each patient's name, an account number for each patient and a future date when each patient should see a caregiver; said instructions periodically cause the microprocessor-based system to review the future date for each patient in the database and create a list of patients who need an appointment with a caregiver within a range of one to seven days of a date on which the microprocessor-based system has reviewed the patients' future dates such the list of patients is displayed on the output device where each patient on the list is called and offered an opportunity to schedule an appointment within the next seven days.

15. The medium of claim 14 wherein said instructions compare a current date of when the microprocessor-based system is reviewed to the future date of each patient and if the current date is within a range of one to seven days of the future date then data from that particular patient are copied into the list of patients and the list is arranged according to priorities assigned to each patient such that patients having a priority code are offered an opportunity to schedule an appointment before those patients on the list who do not have a priority code.

16. The medium of claim 14 further comprising operating instructions which allow a caregiver or caregiver's representative to flag a patient for failing to keep past appointments such that a patient whose patient specific information includes a “wait” designation is no longer scheduled to meet the caregiver and is informed that the patient can only be scheduled as a work-in.

17. The medium of claim 14 further includes operating instructions that allow the caregiver or caregiver's representative to designate a patient as “hold” because the patient is not to be contacted wherein such patients that are designated “hold” patients do not appear in the list of patients, said “hold” patients being accessed from the database using a search feature.

18. The medium of claim 14 further including instructions that cause the output device to display a main screenshot that displays patient information, caregiver information and the list of patients who need to see a caregiver within the next seven days, said main screenshot including a caregiver's daily schedule for a plurality of days divided into time slots into which a patient is scheduled, said main screen further including a day of the week and current date, an A.M. work-in dropdown screen, a P.M. work-in dropdown screen, a patient queue area that displays the list of patients who need appointments within the next seven days, a patient arrival status indicator, encounter code, priority codes, and a calendar feature that displays a month and date such that a caregiver or a caregiver's representative may select whatever month and day to reveal the caregiver's schedule, the main screen further includes a patient demographics area, a tool bar that includes a cancel appointment activation icon, a save activation icon and a back to loop activation icon, a patient balance area that indicates any unpaid balance owed to the caregiver by the patient, wait and hold indicators, an offered appointment field, and a notes entry area. The main screen also displays tabs at the bottom of the page for accessing a “Patient History” page, a “Load” screen page, “Reports” page, and “New Reg” page.

19. The medium of claim 14 wherein said database includes a daily work schedule for at least one caregiver, said daily work schedule comprising time slots, each time slot associated with a patient's name and having an arrival status and encounter code shown on a main screenshot.

20. The medium of claim 14 wherein said microprocessor-based system includes operating instructions and at least one database comprising a plurality of patients' patient specific information including a patient's name, a date-of-birth, an account number, a balance owed, a future date, a telephone number, a priority code, a best-time-to-contact, a patient history, a password, a caregiver number, a caregiver name, an encounter code and a date of last appointment, the at least one database further comprising a provider's address and telephone number and a schedule of the provider's next seven working days arranged as time slots.
